(19) United States
(12) Patent Application Publication
(10) Pub. No.: US 2025/0118462 A1
(43) Pub. Date: Apr. 10, 2025

(54) ELECTRONIC COMPONENT

(71) Applicant: Murata Manufacturing Co., Ltd., Nagaokakyo-shi (JP)

(72) Inventors: Tomoya OOSHIMA, Nagaokakyo-shi (JP); Yuuta HOSHINO, Nagaokakyo-shi (JP)

(73) Assignee: Murata Manufacturing Co., Ltd., Nagaokakyo-shi (JP)

(21) Appl. No.: 18/986,789

(22) Filed: Dec. 19, 2024

Related U.S. Application Data
(63) Continuation of application No. PCT/JP2024/000393, filed on Jan. 11, 2024.

(30) Foreign Application Priority Data
Jun. 19, 2023 (JP) 2023-100195

(51) Int. Cl. H01C 7/04

(52) U.S. Cl. CPC H01C 7/04

(57) ABSTRACT

An electronic component includes a base body and a glass film covering an outer surface of the base body. The glass film has a groove extending on an outer surface of the glass film. The groove is recessed from the outer surface of the glass film toward the outer surface side of the base body in a specific section in a direction orthogonal to the outer surface of the glass film. The bottom portion of the groove is located closer to the outer surface side of the glass film than the outer surface of the base body. In addition, the bottom portion of the groove has an arc shape in the specific section.

### CROSS-REFERENCE TO RELATED APPLICATIONS

This is a continuation application of PCT/JP2024/000393, filed on Jan. 11, 2024, designating the United States of America, which is based on and claims priority to Japanese Patent Application No. JP 2023-100195 filed on Jun. 19, 2023. The entire contents of the above-identified applications, including the specifications, drawings and claims, are incorporated herein by reference in their entirety.

### TECHNICAL FIELD

The present disclosure relates to an electronic component.

### BACKGROUND ART

The disclosure described in Patent Document 1 includes a base body, an internal electrode, a glass layer, and an external electrode. The internal electrode is located inside the base body. The glass layer covers the surface of the base body. The glass layer has a plurality of through holes. The through holes extend from the outer surface of the glass layer to the boundary between the glass layer and the base body. The external electrode is stacked on the outer surface of the glass layer. The external electrode is electrically connected to the internal electrode.

### PRIOR ART DOCUMENT

### Patent Document

Patent Document 1: Japanese Patent No. 6680075

### SUMMARY OF THE DISCLOSURE

### Problem to be Solved by the Disclosure

In the electronic component as in the disclosure described in Patent Document 1, basically, the stress of the glass layer increases as the thickness of the glass layer increases. On the other hand, as described in Patent Document 1, assuming the glass layer has through holes, the stress of the glass layer is released in the through holes. Therefore, in the electronic component, it is possible to suppress concentration of stress at a specific location of the glass layer. However, in the electronic component described in Patent Document 1, since the glass layer has through holes, the barrier property of the glass layer is deteriorated. Therefore, a structure capable of alleviating the stress of the glass layer while suppressing a decrease in the barrier property of the glass layer is preferable.

### Solving the Problem

In order to solve the above problems, one aspect of the present disclosure is an electronic component including: a base body; and a glass film covering an outer surface of the base body, wherein the glass film has a groove that extends on an outer surface of the glass film and is recessed from the outer surface of the glass film toward a side of the outer surface of the base body in a specific section in a direction orthogonal to the outer surface of the glass film, a bottom portion of the groove is located closer to a side of the outer surface of the glass film than the outer surface of the base body, and the bottom portion of the groove has an arc shape in the specific section.

### Advantageous Effect of the Disclosure

According to the above configuration, it is possible to secure the barrier property of the glass film while suppressing stress concentration of the glass film.

### BRIEF EXPLANATION OF DRAWINGS

FIG. 1 is a perspective view of an electronic component.

FIG. 2 is a side view of the electronic component.

FIG. 3 is a sectional view taken along the line 3-3 in FIG. 2.

FIG. 4 is an enlarged view of an outer surface of a glass film of the electronic component.

FIG. 5 is an enlarged view of the vicinity of a glass film assuming the electronic component is viewed in a specific section.

FIG. 6 is an explanatory diagram illustrating the method for manufacturing an electronic component.

FIG. 7 is an explanatory diagram illustrating a method for manufacturing an electronic component.

FIG. 8 is an explanatory diagram illustrating a method for manufacturing an electronic component.

FIG. 9 is an explanatory diagram illustrating a method for manufacturing an electronic component.

FIG. 10 is an explanatory diagram illustrating a method for manufacturing an electronic component.

FIG. 11 is an explanatory diagram illustrating a method for manufacturing an electronic component.

FIG. 12 is an explanatory diagram illustrating the method for manufacturing an electronic component.

FIG. 13 is an enlarged view of the vicinity of a glass film assuming an electronic component of a modification is viewed in a specific section.

### MODE FOR CARRYING OUT THE DISCLOSURE

### Embodiment of Electronic Component

Hereinafter, an embodiment of the electronic component will be described with reference to the drawings. In the drawings, sometimes a component is illustrated while enlarged for the sake of easy understanding. In some cases, the dimension ratio of a component differs from an actual dimension ratio or a dimension ratio in another drawing.

### Overall Configuration

As shown in FIG. 1, an electronic component 10 is, for example, a surface mount negative characteristic thermistor component to be mounted on a circuit board or the like. It is to be noted that the negative characteristic thermistor component has a characteristic that the resistance value is decreased as the temperature is increased.

The electronic component 10 includes a base body 20. The base body 20 has a substantially quadrangular prism shape and has a central axis CA. Hereinafter, an axis extending along the central axis CA is defined as a first axis X. One of the axes orthogonal to the first axis X is defined as a second axis Y. An axis orthogonal to the first axis X and the second axis Y is defined as a third axis Z. Further, one of the directions along the first axis X is defined as a first positive direction X1, and a direction opposite to the first positive direction X1 among the directions along the first axis X is defined as a first negative direction X2. One of the directions along the second axis Y is defined as a second positive direction Y1, and the direction opposite to the second positive direction Y1 among the directions along the second axis Y is defined as a second negative direction Y2. Further, one of the directions along the third axis Z is defined as a third positive direction Z1, and a direction opposite to the third positive direction Z1 among the directions along the third axis Z is defined as a third negative direction Z2.

An outer surface 21 of the base body 20 has six planes. The term “surface” of the base body 20 as used herein refers to a part that can be observed as a surface assuming the entire base body 20 is observed. More specifically, for example, assuming there are such minute irregularities or steps that fail to be found unless a part of the base body 20 is enlarged and then observed with a microscope or the like, the surface is expressed as a plane or a curved surface. The six planes face different directions. The six planes are roughly divided into a first end surface 22A facing the first positive direction X1, a second end surface 22B facing the first negative direction X2, and four side surfaces 22C. The four side surfaces 22C are a surface facing the third positive direction Z1, a surface facing the third negative direction Z2, a surface facing the second positive direction Y1, and a surface facing the second negative direction Y2, respectively.

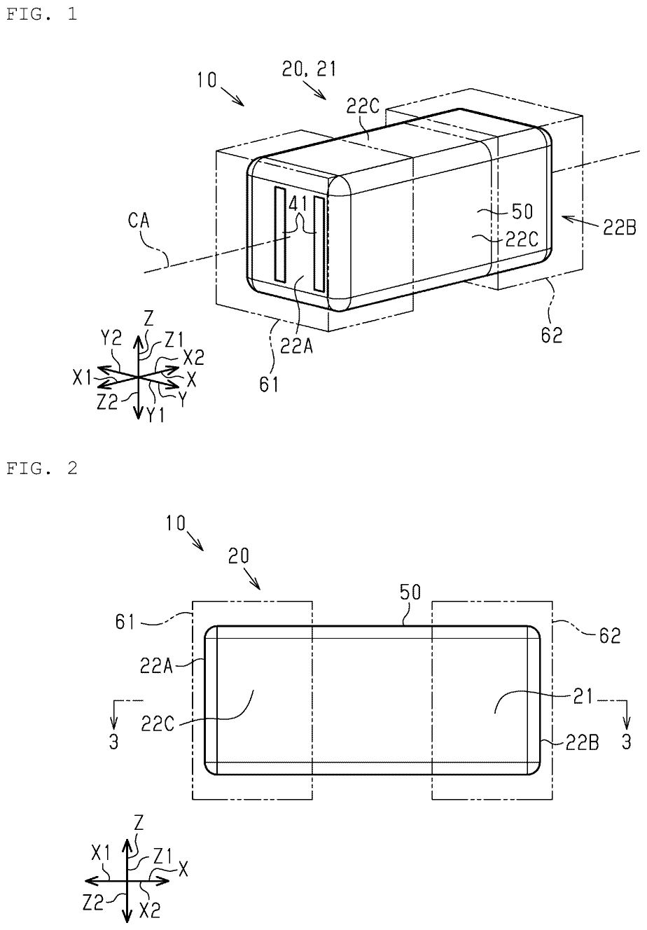

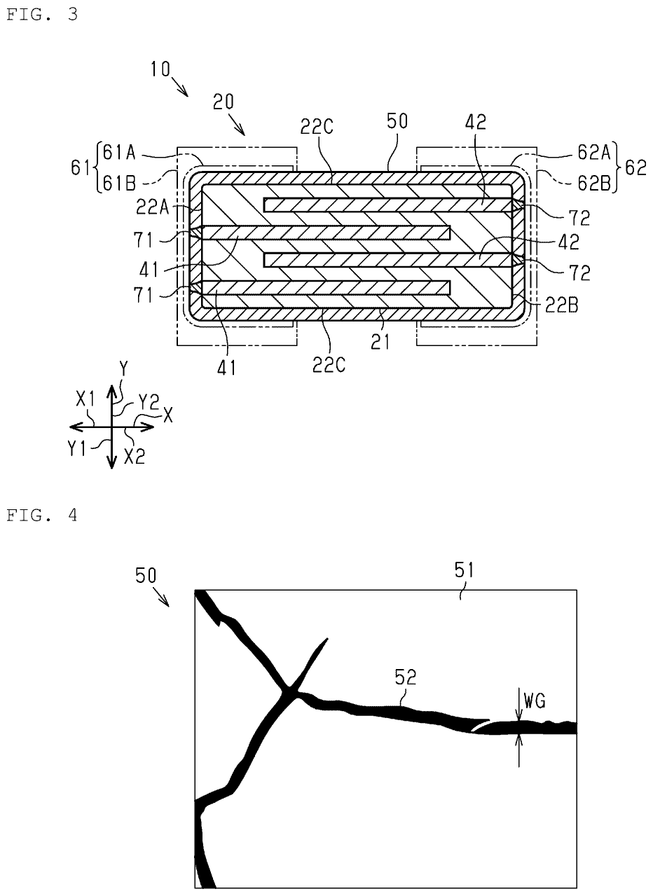

Of the outer surface 21 of the base body 20, a boundary portion between two adjacent planes and a boundary portion between three adjacent planes are curved surfaces. That is, the corners of the base body 20 are round chamfered. In FIGS. 1 and 2, the surface of a glass film 50 to be described later is designated by the same reference numeral as the outer surface 21 of the base body 20.

As illustrated in FIG. 2, the base body 20 has a dimension in the direction along the first axis X larger than a dimension in the direction along the third axis Z. Furthermore, as illustrated in FIG. 1, in the base body 20, the dimension in the direction along the first axis X is larger than the dimension in the direction along the second axis Y. In addition, the material of the base body 20 is a ceramic obtained by firing a metal oxide containing one or more selected from Mn, Fe, Ni, Co, Ti, Ba, Al, and Zn as a component.

As illustrated in FIG. 3, the electronic component 10 includes two first internal electrodes 41 and two second internal electrodes 42. The first internal electrodes 41 and the second internal electrodes 42 are embedded in the base body 20.

The material of the first internal electrode 41 is a conductive material. For example, the material of the first internal electrode 41 is palladium. The material of the second internal electrode 42 is the same as the material of the first internal electrode 41.

The first internal electrode 41 has a rectangular plate shape. The first internal electrode 41 has a main surface orthogonal to the second axis Y. The second internal electrode 42 has the same rectangular plate shape as the first internal electrode 41. A main surface of the second internal electrode 42 is orthogonal to the second axis Y, as with the first internal electrode 41.

The dimension of the first internal electrode 41 in the direction along the first axis X is smaller than the dimension of the base body 20 in the direction along the first axis X. As illustrated in FIG. 1, the dimension of the first internal electrode 41 in the direction along the third axis Z is approximately ⅔ of the dimension of the base body 20 in the direction along the third axis Z. The dimension of the second internal electrode 42 in each of the directions is the same as that of the first internal electrode 41.

As shown in FIG. 3, the first internal electrodes 41 and the second internal electrodes 42 are located in a staggered manner in the direction along the second axis Y. That is, the first internal electrode 41, the second internal electrode 42, the first internal electrode 41, and the second internal electrode 42 are arranged in this order from the side surface 22C facing the second positive direction Y1 toward the second negative direction Y2. In this embodiment, the distances between the respective internal electrodes in the direction along the second axis Y are equal to each other.

As illustrated in FIG. 1, the two first internal electrodes 41 and the two second internal electrodes 42 are both located at the center of the base body 20 in the direction along the third axis Z. On the other hand, as illustrated in FIG. 3, the first internal electrodes 41 are located deviated to the first positive direction X1. The second internal electrodes 42 are located deviated to the first negative direction X2.

Specifically, the end of the first internal electrode 41 on the first positive direction X1 side coincides with the end of the base body 20 on the first positive direction X1 side. The end of the first internal electrode 41 on the first negative direction X2 side is located inside the base body 20 and does not reach the end of the base body 20 on the first negative direction X2 side. On the other hand, the end of the second internal electrode 42 on the first negative direction X2 side coincides with the end of the base body 20 on the first negative direction X2 side. The end of the second internal electrode 42 on the first positive direction X1 side is located inside the base body 20 and does not reach the end of the base body 20 on the first positive direction X1 side.

As illustrated in FIG. 3, the electronic component 10 includes a glass film 50. The glass film 50 covers the outer surface 21 of the base body 20. According to the present embodiment, the glass film 50 covers the whole region of the outer surface 21 of the base body 20. The main material of the glass film 50 is insulating glass. Thus, the glass film 50 contains a silicon dioxide. In addition, the glass film 50 contains, as an additive, one or more elements selected from alkali metals and alkaline earth metals. Specifically, the glass film 50 contains potassium as an additive. Therefore, in the element mapping image in the sectional image of the glass film 50, the glass film 50 may have an interface due to the presence of potassium.

The electronic component 10 includes a first external electrode 61 and a second external electrode 62. The first external electrode 61 includes a first underlying electrode 61A and a first metal layer 61B. The first underlying electrode 61A is stacked on the glass film 50 in a part including the first end surface 22A in the outer surface 21 of the base body 20. Specifically, the first underlying electrode 61A is a five-face electrode that covers the first end surface 22A of the base body 20 and a portion of four side surfaces 22C on the first positive direction X1 side. In this embodiment, the material of the first underlying electrode 61A is silver and glass.

The first metal layer 61B covers the first underlying electrode 61A from the outside. Therefore, the first metal layer 61B is stacked on the first underlying electrode 61A. Although not shown in the drawing, the first metal layer 61B has a two-layer structure of a nickel layer and a tin layer in this order from the first underlying electrode 61A side.

The second external electrode 62 includes a second underlying electrode 62A and a second metal layer 62B. The second underlying electrode 62A is stacked on the glass film 50 in a part including the second end surface 22B in the outer surface 21 of the base body 20. Specifically, the second underlying electrode 62A is a five-surface electrode that covers the second end surface 22B and a part of the four side surfaces 22C on the first negative direction X2 side in the base body 20. According to this embodiment, the material of the second underlying electrode 62A is the same as the material of the first external electrode 61, and is a mixture of silver and glass.

The second metal layer 62B covers the second underlying electrode 62A from the outside. Therefore, the second metal layer 62B is stacked on the second underlying electrode 62A. Specifically, similarly to the first metal layer 61B, the second metal layer 62B has a two-layer structure of nickel plating and tin plating.

The second external electrode 62 does not reach the first external electrode 61 on the side surface 22C, and is disposed away from the first external electrode 61 in the direction along the first axis X. On the side surface 22C of the base body 20, the first external electrode 61 and the second external electrode 62 are not stacked and the glass film 50 is exposed in the central portion in the direction along the first axis X. In FIGS. 1 to 3, the first external electrode 61 and the second external electrode 62 are indicated by two-dot chain lines.

As illustrated in FIG. 3, the first external electrode 61 and the end of the first internal electrode 41 on the first positive direction X1 side are connected via a first extension portion 71 penetrating the glass film 50. Although details will be described later, the first extension portion 71 is formed such that palladium constituting the first internal electrode 41 extends to the first external electrode 61 side in the manufacturing process of the electronic component 10.

The second external electrode 62 and the end of the second internal electrode 42 on the first negative direction X2 side are connected via a second extension portion 72 penetrating the glass film 50. Similarly to the first extension portion 71, the second extension portion 72 is also formed such that palladium constituting the second internal electrode 42 extends to the second external electrode 62 side in the manufacturing process of the electronic component 10. In FIG. 3, the first internal electrode 41 and the first extension portion 71 are illustrated as separate members having a boundary; however, actually, there is no clear boundary therebetween. In this respect, the same applies to the second extension portion 72. In FIGS. 1 and 2, illustration of the first extension portion 71 and the second extension portion 72 is omitted.

### Glass Film

As illustrated in FIG. 4, the glass film 50 has a groove 52 extending on the outer surface 51 of the glass film 50. Assuming the glass film 50 is viewed in a direction orthogonal to the outer surface 51 of the glass film 50, a width of an opening edge 52B of the groove 52 on the outer surface 51 of the glass film 50 is defined as an opening width WG. At this time, assuming the extension length of the opening is 5 times or more the opening width WG, the “groove 52 extending on the outer surface 51 of the glass film 50” is obtained.

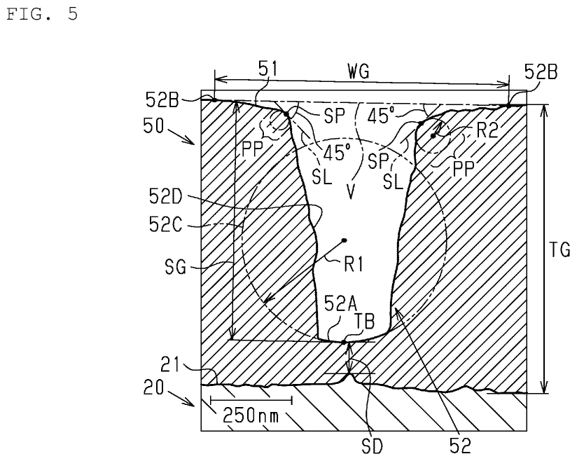

As illustrated in FIG. 5, a section in a direction orthogonal to the outer surface 51 of the glass film 50 is defined as a specific section. In the specific section, the groove 52 is recessed from the outer surface 21 of the glass film 50 toward the outer surface 21 side of the base body 20. A bottom portion 52A of the groove 52 is located closer to the outer surface 51 side of the glass film 50 than the outer surface 21 of the base body 20. That is, the groove 52 does not penetrate the glass film 50.

The bottom portion 52A and the opening edge 52B of the groove 52 are defined as follows. First, the surface of the glass film 50 is captured with an electron microscope. Then, section machining is performed on an arbitrary specific section including the observed groove 52. Then, the element mapping is performed on the specific section to acquire a mapping image in which the boundary between the glass film 50 and the base body 20 and the surface of the glass film 50 opposite to the base body 20 are specified. In the mapping image, a bottommost point TB closest to the outer surface 21 of the base body 20 in the groove 52 is specified. A partial region including the bottommost point TB is the bottom portion 52A.

In addition, in the specific section, the mapping image of the glass film 50 is acquired as described above. Then, in the mapping image, a virtual line V circumscribing both outer surfaces 51 of the glass films 50 on both sides sandwiching the groove 52 is drawn. At this time, a part of the virtual line V may coincide with the outer surface 51 of the glass film 50. Of the contact point between the virtual line V and the outer surface 51 of the glass film 50, an end on the center side of the groove 52 is defined as an opening edge 52B.

In the specific section, the maximum depth SG of the groove 52 is about 750 nm. The maximum depth SG is the larger one of the distances from both opening edges 52B to the bottommost point TB in the direction orthogonal to the virtual line V described above. In this embodiment, the opening width WG is about 870 nm. The opening width WG is a distance from one opening edge 52B to the other opening edge 52B on the virtual line V.

In the specific section, the bottom portion 52A of the groove 52 has an arc shape. In other words, a region including the bottommost point TB in the specific section and having an arc shape is the bottom portion 52A. The “arc” referred to herein may be an arc shape as a whole, ignoring fine irregularities of less than 1 nm that cannot be clearly determined by observation with an electron microscope, for example. In the specific section, the curvature radius R1 of the bottom portion 52A of the groove 52 is 10 nm or more. In the present embodiment, the curvature radius R1 of the bottom portion 52A of the groove 52 is about 315 nm. As described above, the opening width WG of the groove 52 is about 870 nm. Therefore, the curvature radius R1 of the bottom portion 52A is ¼ or more of the opening width WG.

The curvature radius R1 of the bottom portion 52A is defined as follows. First, as described above, the mapping image of the glass film 50 including the bottom portion 52A is acquired. Then, an arc that approximates the surface of the bottom portion 52A is specified in the mapping image. Then, an approximate circle 52C including this arc is specified. The radius of the approximate circle 52C is defined as a curvature radius R1.

In the specific section, a part of an inner wall 52D of the groove 52 has an arc shape. Specifically, a tangent line that is in contact with the inner wall 52D of the groove 52 and is inclined by 45 degrees with respect to the virtual line V is defined as a specific tangent line SL. A contact point between the specific tangent line SL and the inner wall 52D of the groove 52 is defined as a specific contact point SP. At this time, a part PP of the inner wall 52D of the groove 52 including the specific contact point SP has an arc shape. The curvature radius R2 of the part PP is 10 nm or more. In the present embodiment, the curvature radius R2 of the part PP including the specific contact point SP is about 40 nm to 60 nm. In FIG. 5, the curvature radius R2 of one part PP is omitted.

### Thickness of Glass Film

As illustrated in FIG. 5, the shortest distance from the outer surface 21 of the base body 20 to the outer surface 51 of the glass film 50 is defined as the thickness TG of the glass film 50. The average value of the thickness TG of the glass film 50 at a location where the groove 52 does not exist is 300 mm or more. Specifically, in the present embodiment, the average value of the thickness TG of the glass film 50 is about 850 nm. The average value of the thickness TG of the glass film 50 at the location where the groove 52 does not exist is calculated as follows.

First, the location where the groove 52 does not exist on the outer surface 51 of the glass film 50 is specified. Next, a specific section of the glass film 50 at the location is captured with an electron microscope. For this captured image, a range of at least 5 μm or more in a direction along the outer surface 51 of the glass film 50 is defined as a measurement range. Then, the sectional area of the glass film 50 in the measurement range is calculated by image processing. Then, by dividing the sectional area of the glass film 50 in the measurement range by the length of the measurement range in the direction along the outer surface 51 of the glass film 50, the average value of the thickness TG of the glass film 50 is calculated. That is, the average value of the thickness TG of the glass film 50 is an average value of the thickness TG in the measurement range.

In the specific section, the shortest distance SD from the bottom portion 52A of the groove 52 to the outer surface 21 of the base body 20 is about 90 nm. That is, in the specific section, the ratio of the shortest distance SD from the bottom portion 52A of the groove 52 to the outer surface 21 of the base body 20 to the average value of the thickness TG of the glass film 50 is 10% or more. In the present embodiment, the ratio is about 10.6%.

### Method for Manufacturing Electronic Component

Next, the method for manufacturing the electronic component 10 will be described.

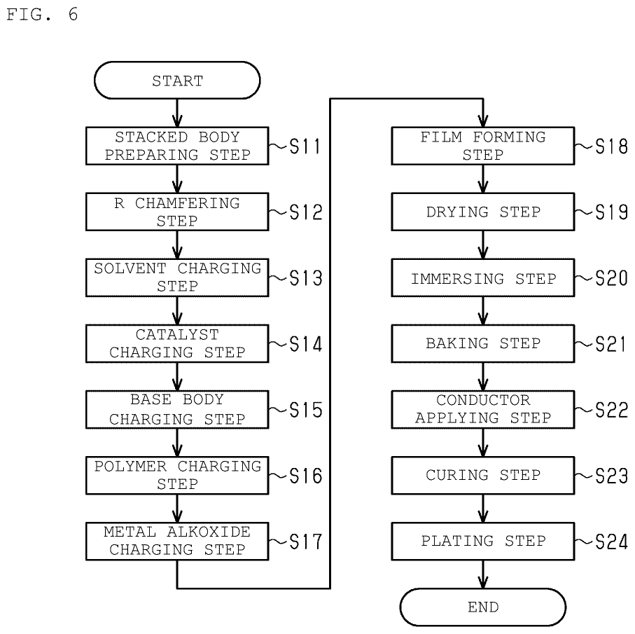

As illustrated in FIG. 6, the method for manufacturing the electronic component 10 includes a stacked body preparing step S11, a R chamfering step S12, a solvent charging step S13, a catalyst charging step S14, a base body charging step S15, a polymer charging step S16, and a metal alkoxide charging step S17. In addition, the method for manufacturing the electronic component 10 further includes a film forming step S18, a drying step S19, an immersing step S20, a baking step S21, a conductor applying step S22, a curing step S23, and a plating step S24.

First, in forming the base body 20, a stacked body that is a cuboid base body 20 is prepared in the stacked body preparing step S11. That is, the stacked body at this stage is in a state before R chamfering. For example, first, a plurality of ceramic sheets to be the base body 20 are provided. Each of the sheets has a thin plate shape. A conductive paste to be the first internal electrode 41 is stacked on the sheet. A ceramic sheet to be the base body 20 is stacked on the stacked paste. A conductive paste to be the second internal electrode 42 is stacked on the sheet. In this manner, the ceramic sheet and the conductive paste are stacked. Then, an unfired stacked body is formed by cutting into a predetermined size. Thereafter, the unfired stacked body is fired at a high temperature to provide a stacked body.

Next, as illustrated in FIG. 6, the R chamfering step S12 is performed. In the R chamfering step S12, a curved surface is formed at a boundary portion between two adjacent planes and a boundary portion between three adjacent planes of the stacked body prepared in the stacked body preparing step S11. For example, the corner of the stacked body is subjected to R chamfering by barrel polishing, whereby a curved surface is formed at the boundary portion.

Next, as shown in FIG. 6, the solvent charging step S13 is performed. As illustrated in FIG. 7, in the solvent charging step S13, 2-propanol is charged as a solvent 82 into a reaction vessel 81.

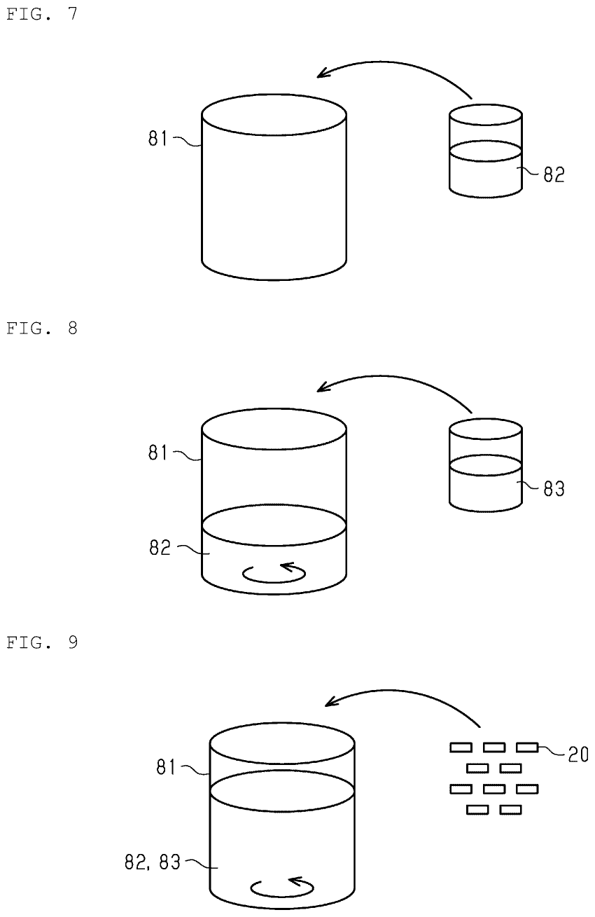

Next, as shown in FIG. 6, the catalyst charging step S14 is performed. As illustrated in FIG. 8, in the catalyst charging step S14, first, stirring of the solvent 82 in the reaction vessel 81 is started. Then, ammonia water is charged into the reaction vessel 81 as an aqueous solution 83 containing the catalyst. The catalyst in this embodiment is a hydroxide ion, and functions as a catalyst that promotes hydrolysis of a metal alkoxide 85 described later.

Next, as illustrated in FIG. 6, the base body charging step S15 is performed. As illustrated in FIG. 9, in the base body charging step S15, the plurality of base bodies 20 formed in advance in the R chamfering step S12 as described above are charged into the reaction vessel 81.

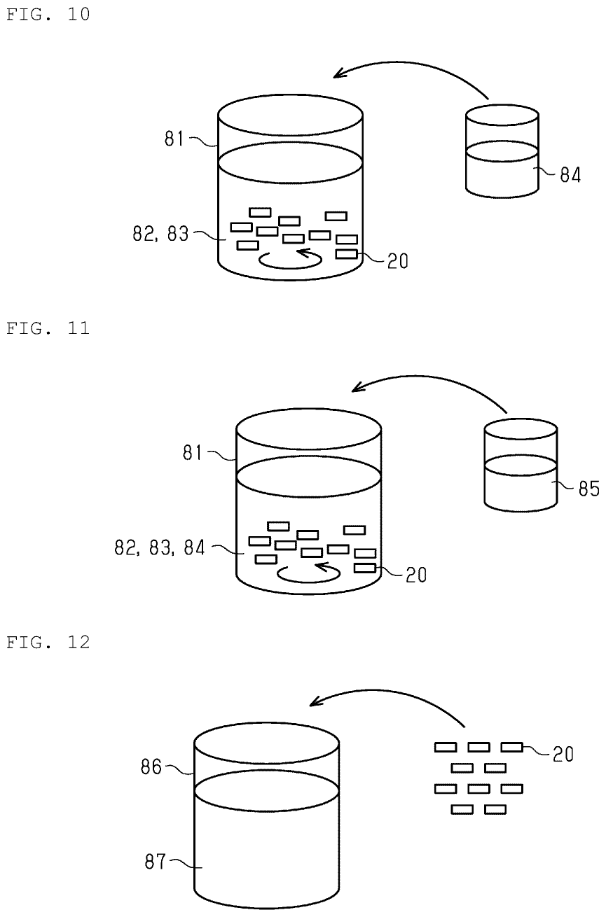

Next, as illustrated in FIG. 6, the polymer charging step S16 is performed. As illustrated in FIG. 10, in the polymer charging step S16, polyvinylpyrrolidone is charged as a polymer 84 into the reaction vessel 81. As a result, the polymer 84 charged into the reaction vessel 81 is attracted to the outer surfaces 21 of the base bodies 20.

Next, as illustrated in FIG. 6, the metal alkoxide charging step S17 is performed. As illustrated in FIG. 11, in the metal alkoxide charging step S17, tetraethyl orthosilicate in a liquid state is charged as the metal alkoxide 85 into the reaction vessel 81. Tetraethyl orthosilicate is sometimes referred to as tetraethoxysilane. In the present embodiment, the amount of the metal alkoxide 85 to be charged in the metal alkoxide charging step S17 is calculated based on the area of the outer surface 21 of the base bodies 20 charged in the base body charging step S15. Specifically, the amount is calculated by multiplying the amount of the metal alkoxide 85 per one base body 20 that is necessary for forming the glass film 50 covering the outer surface 21 of the base bodies 20 by the number of base bodies 20.

Next, as illustrated in FIG. 6, the film forming step S18 is performed. In the film forming step S18, the stirring of the solvent 82 started in the solvent charging step S13 described above is continued for a predetermined time after the metal alkoxide 85 is charged into the reaction vessel 81 in the metal alkoxide charging step S17. Thus, the metal alkoxide 85 is hydrolyzed with the hydroxide ion as a catalyst. Assuming the metal alkoxide 85 is hydrolyzed, the hydrolyzed metal alkoxide 85 adheres to the surfaces of the base bodies 20. Then, the metal alkoxides 85 adhering to the surfaces of the base bodies 20 are dehydrated and condensed to form the glass film 50. In the film forming step S18, the glass film 50 in a sol form is formed by a liquid phase reaction in the reaction vessel 81.

Next, as illustrated in FIG. 6, the drying step S19 is performed. In the drying step S19, the base bodies 20 are, after the film forming step S18, taken out from the reaction vessel 81 and then dried. Thus, the glass film 50 in the sol form is dried to become a glass film 50 in a gel form. In the drying step S19, a crack penetrating the glass film 50 occurs. The crack is formed before being formed as a groove 52 described later. Note that the occurrence of cracking disperses the stress of the glass film 50.

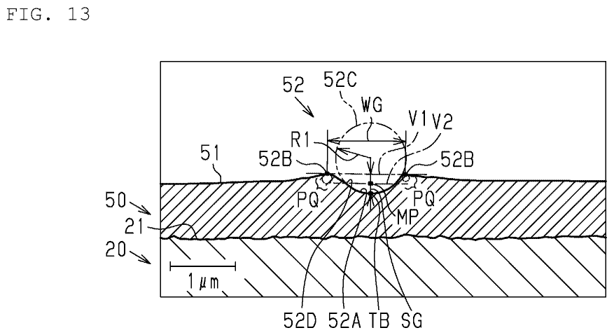

Next, as shown in FIG. 6, the immersing step S20 is performed. As shown in FIG. 12, in the immersing step S20, first, a solution 87 containing, as an additive, at least one element selected from an alkali metal and an alkaline earth metal is placed in advance in a reaction vessel 86 that is different from the reaction vessel 81 used up to the film forming step S18. In the present embodiment, the solution 87 is a solution containing a potassium oxide precursor. Then, the base bodies 20 with the glass film 50 in the gel form is immersed in the solution 87. Thus, the solution 87 adheres to the surface of the glass film 50. Then, the melting point temperature of the glass film 50 decreases.

Next, as illustrated in FIG. 6, the baking step S21 is performed. In the baking step S21, the base bodies 20 immersed in the solution 87 in the immersing step S20 are taken out from the reaction vessel 86. Then, the base bodies 20 taken out are fired in an atmosphere of 800° C. for 20 minutes. As a result, the glass film 50 is eluted. Then, a part of the eluted glass film 50 enters the inside of the crack generated in the drying step S19. As a result, the bottom portion 52A of the glass film 50 is formed on the outer surface 21 of the base body 20 exposed inside the crack of the glass film 50, and the groove 52 is formed. At this time, due to the surface tension, the glass is wetted at a location in contact with the wall surface of the crack. Therefore, the bottom portion 52A has an arc shape in the specific section. In addition, in the baking step S21, the solvent of the solution 87 adhering to the surface of the glass film 50 volatilizes. In contrast, the potassium oxide precursor included in the solution 87 is deposited on the outer surface 51 of the glass film 50.

Next, the conductor applying step S22 is performed. In the conductor applying step S22, a conductor paste is applied to two locations of the surface of the glass film 50: a part including a part that covers the first end surface 22A of the base body 20; and a part including a part that covers the second end surface 22B of the base body 20. Specifically, a conductor paste is applied to a part of the base body 20 on the first positive direction X1 side including the entire region of the first end surface 22 A so as to cover the glass film 50. In addition, a conductor paste is applied to a part of the base body 20 on the first negative direction X2 side including the entire region of the second end surface 22B so as to cover the glass film 50.

Next, the curing step S23 is performed. Specifically, the base bodies 20 with the glass film 50 and conductor paste applied thereto are heated in the curing step S23. Thus, the deposited potassium oxide precursor becomes potassium oxide. The potassium oxide diffuses into the glass film 50 covering the outer surface 21 of the base body 20. Then, water and the polymer 84 are vaporized from the glass film 50 in the gel form, whereby the sol covering a part of the outer surface 21 of the base body 20 is cured. Further, the conductor paste applied to the outer surface 21 of the base body 20 is cured. That is, the first underlying electrode 61A and the second underlying electrode 62A are fired.

In the present embodiment, at the time of heating in the curing step S23, the palladium contained on the side with the first internal electrodes 41 is attracted toward the side with first underlying electrode 61A containing silver by the Kirkendall effect caused from the difference in diffusion rate between the first internal electrodes 41 and the first underlying electrode 61A. As a result, the first extension portion 71 penetrates and extends through the glass film 50 from the first internal electrode 41 toward the first underlying electrode 61A, so that the first internal electrode 41 and the first underlying electrode 61A are connected with each other. In this respect, the same applies to the second extension portion 72 connecting the second internal electrode 42 and the second underlying electrode 62A.

Next, the plating step S24 is performed. Parts of the first underlying electrode 61A and second underlying electrode 62A are subjected to electroplating. As a result, the first metal layer 61B is formed on the surface of the first underlying electrode 61A. In addition, the second metal layer 62B is formed on the surface of the second underlying electrode 62A. Although not illustrated, the first metal layer 61B and the second metal layer 62B are electroplated with two kinds, nickel and tin, to form a two-layer structure. In this way, the electronic component 10 is formed.

### Barrier Property Test

A barrier property test was performed on the base body 20 covered with the glass film 50 having the groove 52. In this test, a plurality of samples of five groups were prepared for each group. That is, a plurality of samples 1, a plurality of samples 2, a plurality of samples 3, a plurality of samples 4, and a plurality of samples 5 were prepared. The glass film 50 was formed by performing the above-described base body charging step S15 to the baking step S21. In addition, for each of samples 1 to 5, the thickness TG and the like of the glass film 50 were made different for each group of samples by changing the conditions of each step. Then, each sample was allowed to stand for 500 hours under the conditions of a temperature of 85° C. and a relative humidity of 90˜95%. Thereafter, the resistance value of each sample was measured. A sample in which the degradation of the resistance value was observed was regarded as a defective product. In this test, a case where the resistance value decreased by 0.1% or more with respect to the resistance value before exposure to the temperature and relative humidity conditions was determined as “the resistance value deteriorated”. A plurality of determinations as to whether or not the sample is a defective product were made for each group of samples, and a generation ratio of defective products for each group was calculated.

In the sample 1, the average value of the thickness TG of the glass film 50 was 300 nm. The average value of the curvature radius R1 of the bottom portion 52A the groove 52 of the sample 1 was 540 nm. The average value of the curvature radius R2 of the part PP of the groove 52 of the sample 1 was 130 nm. In the sample 1, the defective product generation ratio was 0%.

In the sample 2, the average value of the thickness TG of the glass film 50 was 850 nm. The average value of the curvature radius R1 of the bottom portion 52A of the groove 52 of the sample 2 was 310 nm. The average value of the curvature radius R2 of the part PP of the groove 52 of the sample 2 was 10 nm. In the sample 2, the defective product generation ratio was 0%.

In the sample 3, the average value of the thicknesses TG of the glass films 50 was 300 nm. The average value of the curvature radius R1 of the bottom portion 52A of the groove 52 of the sample 3 was 10 nm. The average value of the curvature radius R2 of the part PP of the groove 52 of Sample 3 was 40 nm. In the sample 3, the defective product generation ratio was 0%.

In the sample 4, the average value of the thicknesses TG of the glass films 50 was 100 nm. The average value of the curvature radius R1 of the bottom portion 52A of the groove 52 of Sample 4 was 30 nm. The average value of the curvature radius R2 of the part PP of the groove 52 of Sample 4 was 50 nm. In the sample 4, the defective product generation ratio was 0.3%.

In the sample 5, the average value of the thickness TG of the glass film 50 was 300 nm. The average value of the curvature radius R1 of the bottom portion 52A of the groove 52 of Sample 5 was 3 nm. The average value of the curvature radius R2 of the part PP of the groove 52 of the sample 5 was 8 nm. In the sample 5, the defective product generation ratio was 0.2%.

In the case of the sample 4 in which the defective product occurred, the average value of the thickness TG of the glass film 50 was smaller than that of the other samples. In this case, it was found that the barrier property was deteriorated as compared with the samples 1 to 3. In addition, in the case of the sample 5 in which the defective product occurred, the average value of the curvature radius R1 of the bottom portion 52A of the groove 52 was smaller than that of the other samples. Also in this case, it was found that the barrier property was deteriorated as compared with the samples 1 to 3. In the sample 5, the average value of the curvature radius R2 of the part PP of the groove 52 was smaller than that of the other samples. Also in this case, it was found that the barrier property was deteriorated as compared with other samples 1 to 3.

From the above test, it can be said that the average value of the thickness TG of the glass film 50 is preferably 300 nm or more, and the curvature radius R1 of the bottom portion 52A of the groove 52 is preferably 10 nm or more. In addition, assuming the curvature radius R2 of the part PP of the groove 52 is large, it can be said that other objects are hardly caught in the vicinity of the opening edge 52B of the groove 52. It can be said that the curvature radius R2 of the part PP of the groove 52 is preferably 10 nm or more in order to suppress such catching and secure the characteristics of the product.

### Advantageous Effects of Present Embodiment

(1) According to the above embodiment, since the groove 52 exists in the base body 20, the stress of the glass film 50 is released in the groove 52. Therefore, it is possible to prevent stress from concentrating on a specific location of the glass film 50. The groove 52 does not penetrate the glass film 50. That is, the outer surface 21 of the base body 20 is not exposed to the inside of the groove 52. Therefore, according to the above configuration, the barrier property of the glass film 50 is secured. Further, the bottom portion 52A of the groove 52 has an arc shape. Therefore, it is possible to prevent the groove 52 from extending toward the outer surface 21 side of the base body 20. That is, it is also possible to suppress that the groove 52 unintentionally reaches the base body 20 and the barrier property of the glass film 50 is impaired by the groove 52.

(2) In the above embodiment, in the specific section, the curvature radius R1 of the bottom portion 52A of the groove 52 is 10 nm or more. With this arc size, the curvature of the bottom portion 52A of the groove 52 is secured to some extent. Therefore, the effect described in (1) can be sufficiently obtained.

(3) In the above embodiment, in the specific section, the curvature radius R1 of the bottom portion 52A of the groove 52 is ¼ or more of the opening width WG of the opening edge 52B of the groove 52. That is, the arc shape of the bottom portion 52A of the above embodiment is a sufficiently gentle arc similarly to the arc shape of the bottom portion 52A assuming the groove 52 has a semicircular shape. As described above, assuming the arc of the bottom portion 52A is gentle, for example, assuming an external force acts on the glass film 50, the groove 52 can be suitably prevented from developing with the bottom portion 52A as a starting point.

(4) In the above embodiment, the part PP including the specific contact point SP of the inner wall 52D of the groove 52 has an arc shape. The curvature radius R2 of the part PP is 10 nm or more. Here, the specific contact point SP of the inner wall 52D is a location where the inclination of the groove 52 becomes steep to 45 degrees or more. Therefore, a location corresponding to the specific contact point SP is a location that is easily caught assuming another object is rubbed against the electronic component 10. In this respect, as described above, since the part PP including the specific contact point SP is rounded, another object is less likely to be caught at the location of the groove 52 corresponding to the specific contact point SP. By suppressing such catching, the scratch resistance of the glass film 50 is improved.

(5) In the above embodiment, the average value of the thickness TG of the glass film 50 at a location where the groove 52 does not exist is 300 nm or more. According to this configuration, the barrier property of the glass film 50 is sufficiently secured.

(6) In the above embodiment, in the specific sectional view, the ratio of the shortest distance SD from the bottom portion 52A of the groove 52 to the outer surface 21 of the base body 20 to the average value of the thickness TG of the glass film 50 is 10% or more. According to this configuration, in a location where the glass film 50 is thinnest, a corresponding film thickness of the glass film 50 is secured. That is, the barrier property of the glass film 50 is secured.

### Modification Examples

The above-mentioned embodiment and the following modification examples can be implemented in combination within a range that is not technically contradictory.
The electronic component 10 is not limited to a negative characteristic thermistor component. For example, it may be a multilayer capacitor component or an inductor component.
The material of the base body 20 is not limited to the example of the embodiment. The material of the base body 20 may be a composite of a resin and a metal powder.
The shape of the base body 20 is not limited to the example of the embodiment. For example, the base body 20 may have a polygonal columnar shape, other than a quadrangular columnar shape, having a central axis CA. Furthermore, the base body 20 may be the core of a wire-wound inductor component. For example, the core may have what is called a drum core shape. Specifically, the core may have a columnar winding core portion and a flange portion provided at each end of the winding core portion.
Of the outer surface 21 of the base body 20, a boundary portion between the adjacent planes may not have a chamfered shape. In this case, there is no curved surface at the boundary portion.
The shapes of the first internal electrode 41 and the second internal electrode 42 are not limited as long as they can ensure electrical conduction with the corresponding first external electrode 61 and second external electrode 62. The number of the first internal electrodes 41 and the number of the second internal electrodes 42 are not limited, and the number of the internal electrodes may be one or may be three or more.
The configuration of the first external electrode 61 is not limited to the example of the embodiment. For example, the first external electrode 61 may include only the first underlying electrode 61A, or the first metal layer 61B does not necessarily have a two-layer structure. In this respect, the same applies to the second external electrode 62.
The material combination of the first internal electrode 41 and the first underlying electrode 61A is not limited to the combination of palladium and silver. For example, a combination of copper and nickel, copper and silver, silver and gold, nickel and cobalt, or nickel and gold may be used. For example, one may be silver, and the other may be a combination of silver and palladium. For example, one may be palladium and the other may be a combination of silver and palladium, or one may be copper and the other may be a combination of silver and palladium. For example, one may be gold, and the other may be a combination of silver and palladium.
In some combinations of the first internal electrode 41 and the first underlying electrode 61A, the Kirkendall effect cannot be obtained. In this case, before the conductor applying step S22, the first internal electrode 41 may be processed in such a manner of being exposed from the glass film 50. For example, the glass film 50 on the first end surface 22A side of the base body 20 may be polished to physically remove a part of the glass film 50. Thereafter, the first internal electrode 41 and the first underlying electrode 61A can be connected by performing the conductor applying step S22. Alternatively, for example, after the first underlying electrode 61A is formed, the glass film 50 may be formed on a region including the surface of the first underlying electrode 61A, and the glass film 50 covering the surface of the first underlying electrode 61A may be removed. In this respect, the same applies to the material combination of the second internal electrode 42 and the second underlying electrode 62A.
The arrangement location of the first external electrode 61 is not limited to the example of the embodiment. For example, the first external electrode 61 may be disposed only on the first end surface 22A and one side surface 22C. In this respect, the same applies to the second external electrode 62.
In the specific section of the above embodiment, the curvature radius R1 of the bottom portion 52A of the groove 52 may be less than 10 nm. Assuming at least the bottom portion 52A has an arc shape, the effect described in (1) can be expected.
In the specific section of the above embodiment, the curvature radius R2 of the part PP including the specific contact point SP in the inner wall 52D of the groove 52 may be less than 10 nm. The part PP may not have an arc shape.
In the above embodiment, a part including the opening edge 52B of the glass film 50 may have an arc shape. In the example illustrated in FIG. 13, the glass film 50 has a groove 52 extending on the outer surface 51 of the glass film 50. A section in a direction orthogonal to outer surface 51 of glass film 50 is defined as a specific section. In the specific section, the groove 52 is recessed from the outer surface 21 of the glass film 50 toward the outer surface 21 side of the base body 20. A bottom portion 52A of the groove 52 is located closer to the outer surface 51 side of the glass film 50 than the outer surface 21 of the base body 20. That is, the groove 52 does not penetrate the glass film 50. In the specific section, the bottom portion 52A of the groove 52 has an arc shape. In the example illustrated in FIG. 13, the curvature radius R1 of the bottom portion 52A of the groove 52 is about 1 μm.

In the example illustrated in FIG. 13, the part PQ including the opening edge 52B of the groove 52 has an arc shape in the specific section. Specifically, the part PQ has an arc shape protruding toward the opposite side to the base body 20. The curvature radius of the part PQ is 10 nm or more. In the example illustrated in FIG. 13, the curvature radius of the arc of the part PQ is about 10 to 30 nm.

In the example illustrated in FIG. 13, the opening width WG of the opening edge 52B of the groove 52 is about 1.2 μm in the specific section. That is, in the specific section, the curvature radius R1 of the bottom portion 52A of the groove 52 is ¼ or more of the opening width WG of the opening edge 52B of the groove 52.

In addition, as in the example illustrated in FIG. 13, it is assumed that a first virtual line V1 connecting the opening edges 52B on both sides of the groove 52 is drawn in the specific section. Then, it is assumed that a position where the maximum depth SG of the groove 52 is half is an intermediate position MP, and a second virtual line V2 that passes through the intermediate position MP and is parallel to the first virtual line V1 is drawn. In the specific section, the value obtained by doubling the curvature radius R1 of the bottom portion 52A of the groove 52 is preferably equal to or greater than the length at which the second virtual line V2 is delimited by the inner wall 52D of the groove 52 in the specific section. According to such a configuration, the arc of the bottom portion 52A of the groove 52 is larger than the scale of the opening width WG of the groove 52. Therefore, stress is sufficiently dispersed at the bottom portion 52A of the glass film 50 at the bottom portion 52A of the groove 52. Although not illustrated, also in the above embodiment, the value obtained by doubling the curvature radius R1 of the bottom portion 52A of the groove 52 is equal to or greater than the length at which the second virtual line V2 is delimited by the inner wall 52D of the groove 52 in the specific section.
In the above embodiment, the average value of the thickness TG of the glass film 50 at a location where the groove 52 does not exist may be less than 300 nm. In addition, in the specific section, the ratio of the shortest distance SD from the bottom portion 52A of the groove 52 to the outer surface 21 of the base body 20 to the average value of the thickness TG of the glass film 50 may be less than 10%. That is, the bottom portion 52A of the groove 52 may be located closer to the outer surface 51 side of the glass film 50 than the outer surface 21 of the base body 20.
The configuration of the glass film 50 is not limited to the example of the above embodiment. For example, not all the regions of the outer surface 21 of the base body 20 may be covered. The range covered with the glass film 50 may be appropriately changed in accordance with the shape of the base body 20, the positions of the first external electrode 61 and the second external electrode 62, and the like.
The glass film 50 and the first underlying electrode 61A may be integrated by diffusion of glass contained in the glass film 50 into the first underlying electrode 61A. The same applies to the glass film 50 and the second underlying electrode 62A.
The glass film 50 may not contain one or more elements selected from an alkali metal and an alkaline earth metal as an additive.
The material of the glass film 50 is not limited to the example of the embodiment. For example, the glass is not limited to silicon dioxide, and may be a multicomponent oxide containing Si, such as a B—Si-based, Si—Zn-based, Zr—Si-based, or Al—Si-based oxide. In addition, the glass may be a multicomponent oxide containing an alkali metal and Si, such as an Al—Si-based, Na—Si-based, or Li—Si-based oxide. Furthermore, the glass may be a multicomponent oxide containing an alkaline earth metal and Si, such as an Mg—Si-based, Ca—Si-based, Ba—Si-based, or Sr—Si-based oxide. The glass does not have to contain Si, and may be a mixture thereof.
The material of the glass film 50 may contain, in addition to the glass, a surface treatment agent or an antistatic agent, such as a pigment, a silicone-based flame retardant, a silane coupling agent, or a titanate coupling agent.

More specifically, the glass film 50 may contain additives of an organic acid salt, an oxide, an inorganic salt, an organic salt, and other fine particles or nanoparticles of a metal oxide in addition to glass. In addition, the additive contained in the solution 87 is not limited to the potassium oxide precursor.

Examples of the organic acid salt include salts of oxo acids such as soda ash, sodium carbonate, sodium hydrogen carbonate, sodium percarbonate, sodium sulfite, sodium hydrogen sulfite, sodium sulfate, sodium thiosulfate, sodium nitrate, and sodium sulfite, and halogen compounds such as sodium fluoride, sodium chloride, sodium bromide, and sodium iodide.

Examples of the oxides include sodium peroxide, and examples of the hydroxides include sodium hydroxide.

Examples of the inorganic salt include sodium hydride, sodium sulfide, sodium hydrogen sulfide, sodium silicate, trisodium phosphate, sodium borate, sodium borohydride, sodium cyanide, sodium cyanate, and sodium tetrachloroaurate.

In addition, examples of the inorganic salts include calcium peroxide, calcium hydroxide, calcium fluoride, calcium chloride, calcium bromide, calcium iodide, calcium hydride, calcium carbide, and calcium phosphide.

The additive may be an oxoacid salt such as calcium carbonate, calcium hydrogen carbonate, calcium nitrate, calcium sulfate, calcium sulfite, calcium silicate, calcium phosphate, calcium pyrophosphate, calcium hypochlorite, calcium chlorate, calcium perchlorate, calcium bromate, calcium iodate, calcium arsenite, calcium chromate, calcium tungstate, calcium molybdate, calcium magnesium carbonate, or hydroxyapatite. Examples of the additive include calcium acetate, calcium gluconate, calcium citrate, calcium malate, calcium lactate, calcium benzoate, calcium stearate, and calcium aspartate.

For example, the additive may be lithium carbonate, lithium chloride, lithium titanate, lithium nitride, lithium peroxide, lithium citrate, lithium fluoride, lithium hexafluorophosphate, lithium acetate, lithium iodide, lithium hypochlorite, lithium tetraborate, lithium bromide, lithium nitrate, lithium hydroxide, lithium aluminum hydride, lithium triethylborohydride, lithium hydride, lithium amide, lithium imide, lithium diisopropylamide, lithium tetramethylpiperide, lithium sulfide, lithium sulfate, lithium thiophenolate, or lithium phenoxide.

For example, the additive may be boron triiodide, sodium cyanoborohydride, sodium borohydride, tetrafluoroboric acid, triethylborane, borax, or boric acid.

For example, the additive may be barium sulfite, barium chloride, barium chlorate, barium perchlorate, barium peroxide, barium chromate, barium acetate, barium cyanide, barium bromide, barium oxalate, barium nitrate, barium hydroxide, barium hydride, barium carbonate, barium iodide, barium sulfide, or barium sulfate. In addition, the additive may be sodium acetate or sodium citrate.

The additive may be fine particles or nanoparticles of a metal oxide, and examples of the metal oxide include sodium oxide, calcium oxide, lithium oxide, boron oxide, barium oxide, silicon oxide, titanium oxide, zircon oxide, aluminum oxide, zinc oxide, and magnesium oxide.

In addition, in the embodiment mentioned above, examples of the potassium oxide precursor include potassium arsenide, potassium bromide, potassium carbide, potassium chloride, potassium fluoride, potassium hydride, potassium iodide, potassium triiodide, potassium azide, potassium nitride, potassium superoxide, potassium ozonide, potassium peroxide, potassium phosphide, potassium sulfide, potassium selenide, potassium telluride, potassium tetrafluoroaluminate, potassium tetrafluoroborate, potassium tetrahydroborate, potassium methanide, potassium cyanide, potassium formate, potassium hydrogen fluoride, potassium tetraiodomercurate (II), potassium hydrogen sulfide, potassium octachlorodimolybdate (II), potassium amide, potassium hydroxide, potassium hexafluorophosphate, potassium carbonate, potassium tetrachloroplatinate (II), potassium hexachloroplatinate (IV), potassium nonahydridorhenate (VII), potassium sulfate, potassium acetate, gold(I) potassium cyanide, potassium hexanitritocobaltate (III), potassium hexacyanoferrate (III), potassium hexacyanoferrate (II), potassium methoxide, potassium ethoxide, potassium tert-butoxide, potassium cyanate, potassium fulminate, potassium thiocyanate, potassium aluminum sulfate, potassium aluminate, potassium arsenate, potassium bromate, potassium hypochlorite, potassium chlorite, potassium chlorate, potassium perchlorate, potassium carbonate, potassium chromate, potassium dichromate, potassium tetrakis(peroxo) chromate (V), potassium cuprate (III), potassium ferrate, potassium iodate, potassium periodate, potassium permanganate, potassium manganate, potassium hypomanganate, potassium molybdate, potassium nitrite, potassium nitrate, tripotassium phosphate, potassium perrhenate, potassium selenate, potassium silicate, potassium sulfite, potassium sulfate, potassium thiosulfate, potassium disulfite, potassium dithionate, potassium disulfate, potassium peroxodisulfate, potassium dihydrogenarsenate, dipotassium hydrogen arsenate, potassium hydrogen carbonate, potassium dihydrogen phosphate, dipotassium hydrogen phosphate, potassium hydrogen selenate, potassium hydrogen sulfite, potassium hydrogen sulfate, and potassium hydrogen peroxosulfate.

The metal alkoxide 85 may be, for example, sodium methoxide, sodium ethoxide, calcium diethoxide, lithium isopropoxide, lithium ethoxide, lithium tert-butoxide, lithium methoxide, boron alkoxides, potassium t-butoxide, tetraethyl orthosilicate, allyltrimethoxysilane, isobutyl(trimethoxy)silane, tetrapropyl orthosilicate, tetramethyl orthosilicate, [3-(diethylamino)propyl]trimethoxysilane, triethoxy(octyl)silane, triethoxyvinylsilane, triethoxyphenylsilane, trimethoxyphenylsilane, trimethoxymethylsilane, butyltrichlorosilane, n-propyltriethoxysilane, methyltrichlorosilane, dimethoxy(methyl)octylsilane, dimethoxydimethylsilane, tris(tert-butoxy)silanol, tris(tert-pentoxy)silanol, hexadecyltrimethoxysilane, dipotassium tris (1,2-benzenediolato-O,O′)silicate, tetrabutyl orthosilicate, aluminum silicate, calcium silicate, a tetramethylammonium silicate solution, chlorotriisopropoxytitanium (IV), titanium (IV) isopropoxide, titanium (IV) 2-ethylhexyl oxide, titanium (IV) ethoxide, titanium (IV) butoxide, titanium (IV) tert-butoxide, titanium (IV) propoxide, titanium (IV) methoxide, zirconium (IV) bis(diethyl citrato) dipropoxide, zirconium (IV) dibutoxide(bis-2,4-pentanedionate), zirconium (IV) 2-ethylhexanoate, a zirconium (IV) isopropoxide isopropanol complex, zirconium (IV) ethoxide, zirconium (IV) butoxide, zirconium (IV) tert-butoxide, zirconium (IV) propoxide, aluminum tert-butoxide, aluminum isopropoxide, aluminum ethoxide, aluminum-tri-sec-butoxide, or aluminum phenoxide.
In the above embodiment, the method for manufacturing the electronic component 10 may be a method different from the above embodiment. For example, the glass film 50 may be formed by the following method. First, a thin film to be a base of the glass film 50 is formed on the outer surface 21 of the base body 20 by a barrel playing method or the like with respect to the base body 20 subjected to the chamfering processing. Then, an additive containing at least one element selected from an alkali metal and an alkaline earth metal is added to the thin film to form the glass film 50.
The solvent 82 charged in the solvent charging step S13 is not limited to the example of the embodiment mentioned above, and may be any liquid that can disperse the metal alkoxide 85 appropriately.
The solvent charging step S13 may be performed after the catalyst charging step S14 and the base body charging step S15. The solvent charging step S13 may be performed before at least any one of the metal alkoxide charging step S17 and the catalyst charging step S14. In addition, the solvent charging step S13 may be omitted. In this case, for example, assuming the amount of water contained in the aqueous solution 83 containing the catalyst is appropriately large, the metal alkoxide 85 reacts in the liquid phase. In addition, the aqueous solution 83 containing the catalyst may be charged in a state of being mixed with an organic solvent as the solvent 82.
The aqueous solution 83 containing the catalyst is ammonia water, and the catalyst is a hydroxide ion, but the catalyst is not limited thereto. As with the ammonia water according to the embodiment mentioned above, basic aqueous solutions are capable of catalyzing the hydrolysis of the metal alkoxide 85, and acidic aqueous solutions are also capable of catalyzing the hydrolysis of the metal alkoxide 85. Furthermore, neutral aqueous solutions may be also employed, as long as the aqueous solutions contain therein ions or the like capable of catalyzing the hydrolysis.
Although it has been described that the catalyst is charged as the aqueous solution 83 containing the catalyst, a solid compound containing the catalyst and water may be separately charged into the reaction vessel 81. In this case, it can be considered that the catalyst is charged into the reaction vessel 81 because the catalyst is generated in the reaction vessel 81. In addition, for example, a solid compound containing the catalyst may be charged into the reaction vessel 81, and moisture in the air may be used as water for the hydrolysis.
The base body charging step S15 may be performed before the catalyst charging step S14. In addition, assuming the base body charging step S15 is performed before the catalyst charging step S14, the metal alkoxide charging step S17 may be performed before the catalyst charging step S14 or the base body charging step S15. The base body charging step S15 may be performed before at least any one of the metal alkoxide charging step S17 and the catalyst charging step S14.
In the method for manufacturing the electronic component 10 according to the above embodiment, a solution containing a precursor for generating the metal alkoxide 85 may be charged instead of the metal alkoxide 85. In this case, in the metal alkoxide charging step S17, the metal complex or acetate as the metal alkoxide precursor only needs to be charged. Examples of the metal complex include acetylacetonates such as lithium acetylacetonate, titanium (IV) oxyacetylacetonate, titanium diisopropoxide bis(acetylacetonate), zirconium (IV) trifluoroacetylacetonate, zirconium (IV) acetylacetonate, aluminum acetylacetonate, aluminum (III) acetylacetonate, calcium (II) acetylacetonate, and zinc (II) acetylacetonate. Examples of the acetate include zirconium acetate, zirconium (IV) acetate hydroxide, and basic aluminum acetate.
In the metal alkoxide charging step S17, the metal alkoxide 85 may be generated in the reaction vessel 81 without being charged into the reaction vessel 81 after the metal alkoxide 85 is generated outside the reaction vessel 81. For example, the metal alkoxide 85 is produced by a reaction between a metal salt and an alcohol. Thus, the metal alkoxide 85 can be considered as being charged in the reaction vessel 81, also based on the fact that the metal salt that is a metal alkoxide precursor and the alcohol are charged into the reaction vessel 81 and then allowed to react with each other to produce the metal alkoxide 85.
The metal alkoxide 85 is not limited to any tetraethyl orthosilicate. For example, titanium, zirconium, aluminum, or the like may be used for the metal contained in the metal alkoxide 85. Further, assuming the metal contained in the metal alkoxide 85 is silicon, the reaction rate of the metal alkoxide 85 is easily controlled to be constant, because the reaction rate is lower than that of other metals. In addition, as for the alkoxy group of the metal alkoxide 85, a methoxy group, a propoxy group, or the like may be used, or a functional group such as a long-chain alkyl group or an epoxy group may be modified like a coupling agent. Furthermore, the coordination number with respect to the metal contained in the metal alkoxide 85 is not limited to being four-coordination, and may be three-coordination or two-coordination.
The reaction vessel 81 used in the immersing step S20 and the reaction vessel 86 used in the film forming step S18 do not need to be different.
In the immersing step S20, the solution 87 has only to adhere to the glass film 50 covering the outer surface 21 of the base body 20, and thus, the base body 20 may be optionally immersed in the solution 87 in the reaction vessel 86. For example, the solution 87 may be applied only to the part covered with the glass film 50 at the outer surface 21 of the base body 20. The method for adding an alkali metal and an alkaline earth metal to the glass film 50 in the gel form is not limited to the immersion method, and the alkali metal and the alkaline earth metal may be added by spraying or the like.
The curing step S23 is not limited to the step of simultaneously curing the glass film 50 and the conductor paste. For example, as long as the conductor paste is a material that is cured by ultraviolet irradiation, a heating step may be performed as a step of curing the glass film 50, and ultraviolet irradiation may be performed as a step of curing the conductor paste.
In the above embodiment, after performing the base body charging step S15 to the drying step S19 once, the base body charging step S15 to the drying step S19 may be repeatedly performed again. By repeatedly performing these steps, the thickness TG of the glass film 50 increases.
In the above embodiment, after the immersing step S20 and the baking step S21 are performed once, the immersing step S20 and the baking step S21 may be repeatedly performed again. By repeatedly performing these steps, the shortest distance SD from the bottom portion 52A of the groove 52 to the outer surface 21 of the base body 20 increases, and the curvature radius R1 of the bottom portion 52A changes.

### Supplementary Note

Technical ideas that can be derived from the above embodiments and modification examples will be described below.

[1] An electronic component including: a base body; and a glass film covering an outer surface of the base body, wherein the glass film has a groove that extends on an outer surface of the glass film and is recessed from the outer surface of the glass film toward a side of the outer surface of the base body in a specific section in a direction orthogonal to the outer surface of the glass film, a bottom portion of the groove is located closer to a side of the outer surface of the glass film than the outer surface of the base body, and the bottom portion of the groove has an arc shape in the specific section.

[2] The electronic component according to [1], wherein in the specific section, a curvature radius of the bottom portion of the groove is 10 nm or more.

[3] The electronic component according to [1] or [2], wherein, in the specific section, a curvature radius of the bottom portion of the groove is ¼ or more of a width of an opening edge of the groove.

[4] The electronic component according to any one of [1] to [3], wherein, in the specific section, assuming a line connecting opening edges on both sides of the groove is an virtual line, a tangent line that is in contact with an inner wall of the groove and inclined by 45 degrees with respect to the virtual line is a specific tangent line, and a contact point between the specific tangent line and the inner wall of the groove is a specific contact point, a part of an inner wall of the groove including the specific contact point has an arc shape, and a curvature radius of the part is 10 nm or more.

[5] The electronic component according to any one of [1] to [4], wherein an average value of thicknesses of the glass film at a location where the groove does not exist is 300 nm or more.

[6] The electronic component according to any one of [1] to [5], wherein, in the specific section, a ratio of a shortest distance from a bottom portion of the groove to an outer surface of the base body to an average value of thicknesses of the glass film is 10% or more.

### DESCRIPTION OF REFERENCE SYMBOLS

10: Electronic component
20: Base body
21: Outer surface
50: Glass film
51: Outer surface
52: Groove
52A: Bottom portion
52B: Opening edge

1. An electronic component comprising:
a base body; and
a glass film covering an outer surface of the base body, wherein
the glass film has a groove that extends on an outer surface of the glass film and is recessed from the outer surface of the glass film toward a side of the outer surface of the base body in a specific section in a direction orthogonal to the outer surface of the glass film,
a bottom portion of the groove is located closer to a side of the outer surface of the glass film than the outer surface of the base body, and
the bottom portion of the groove has an arc shape in the specific section.

2. The electronic component according to claim 1, wherein in the specific section, a curvature radius of the bottom portion of the groove is 10 nm or more.

3. The electronic component according to claim 2, wherein in the specific section, a curvature radius of the bottom portion of the groove is ¼ or more of a width of an opening edge of the groove.

4. The electronic component according to claim 3, wherein,
in the specific section, assuming a line connecting opening edges on both sides of the groove is defined as an virtual line, a tangent line that is in contact with an inner wall of the groove and inclined by 45 degrees with respect to the virtual line is defined as a specific tangent line, and a contact point between the specific tangent line and the inner wall of the groove is defined as a specific contact point,
in the specific section, a part of the inner wall of the groove including the specific contact point has an arc shape, and
a curvature radius of the part is 10 nm or more.

5. The electronic component according to claim 4, wherein an average value of thicknesses of the glass film at a location where the groove does not exist is 300 nm or more.

6. The electronic component according to claim 5, wherein in the specific section, a ratio of a shortest distance from a bottom portion of the groove to an outer surface of the base body to an average value of thicknesses of the glass film is 10% or more.

7. The electronic component according to claim 2, wherein,
in the specific section, assuming a line connecting opening edges on both sides of the groove is defined as an virtual line, a tangent line that is in contact with an inner wall of the groove and inclined by 45 degrees with respect to the virtual line is defined as a specific tangent line, and a contact point between the specific tangent line and the inner wall of the groove is defined as a specific contact point,
in the specific section, a part of the inner wall of the groove including the specific contact point has an arc shape, and
a curvature radius of the part is 10 nm or more.

8. The electronic component according to claim 7, wherein an average value of thicknesses of the glass film at a location where the groove does not exist is 300 nm or more.

9. The electronic component according to claim 8, wherein in the specific section, a ratio of a shortest distance from a bottom portion of the groove to an outer surface of the base body to an average value of thicknesses of the glass film is 10% or more.

10. The electronic component according to claim 1, wherein,
in the specific section, assuming a line connecting opening edges on both sides of the groove is defined as an virtual line, a tangent line that is in contact with an inner wall of the groove and inclined by 45 degrees with respect to the virtual line is defined as a specific tangent line, and a contact point between the specific tangent line and the inner wall of the groove is defined as a specific contact point,
in the specific section, a part of the inner wall of the groove including the specific contact point has an arc shape, and
a curvature radius of the part is 10 nm or more.

11. The electronic component according to claim 10, wherein an average value of thicknesses of the glass film at a location where the groove does not exist is 300 nm or more.

12. The electronic component according to claim 11, wherein in the specific section, a ratio of a shortest distance from a bottom portion of the groove to an outer surface of the base body to an average value of thicknesses of the glass film is 10% or more.

13. The electronic component according to claim 2, wherein,
in the specific section, assuming a line connecting opening edges on both sides of the groove is defined as an virtual line, a tangent line that is in contact with an inner wall of the groove and inclined by 45 degrees with respect to the virtual line is defined as a specific tangent line, and a contact point between the specific tangent line and the inner wall of the groove is defined as a specific contact point,
in the specific section, a part of the inner wall of the groove including the specific contact point has an arc shape, and
a curvature radius of the part is 10 nm or more.

14. The electronic component according to claim 13, wherein an average value of thicknesses of the glass film at a location where the groove does not exist is 300 nm or more.

15. The electronic component according to claim 14, wherein in the specific section, a ratio of a shortest distance from a bottom portion of the groove to an outer surface of the base body to an average value of thicknesses of the glass film is 10% or more.

16. The electronic component according to claim 1, wherein an average value of thicknesses of the glass film at a location where the groove does not exist is 300 nm or more.

17. The electronic component according to claim 16, wherein in the specific section, a ratio of a shortest distance from a bottom portion of the groove to an outer surface of the base body to an average value of thicknesses of the glass film is 10% or more.

18. The electronic component according to claim 2, wherein an average value of thicknesses of the glass film at a location where the groove does not exist is 300 nm or more.

19. The electronic component according to claim 18, wherein in the specific section, a ratio of a shortest distance from a bottom portion of the groove to an outer surface of the base body to an average value of thicknesses of the glass film is 10% or more.

20. The electronic component according to claim 1, wherein in the specific section, a ratio of a shortest distance from a bottom portion of the groove to an outer surface of the base body to an average value of thicknesses of the glass film is 10% or more.
